(19) United States
(12) Patent Application Publication
(10) Pub. No.: US 2002/0085456 A1
(43) Pub. Date: Jul. 4, 2002

(54) Music piece data managing apparatus and in-vehicle audio information reproduction control system

(76) Inventors: Tatsuya Yanagisawa, Kawagoe-shi (JP); Hiroyuki Kohchi, Kawagoe-shi (JP)

Correspondence Address: Finnegan, Henderson, Farabow,, Garrett & Dunner, L.L.P., 1300 I Street, N.W., Washington, DC, 20005-3315, US

(21) Appl. No.: 09/982,796

(22) Filed: Oct. 22, 2001

(30) Foreign Application Priority Data
Oct. 24, 2000 (JP) 2000-323730

(51) Int. Cl. H04B 1/20

(52) U.S. Cl. 369/1

(57) ABSTRACT

An in-vehicle audio information reproduction control system with which the order of reproduction can be easily edited for music pieces which are stored onto a hard disk of the in-vehicle audio information reproducing apparatus. A music piece data managing apparatus is provided at a place which is away from the in-vehicle audio information reproducing apparatus and having an environment good for installation. Only the music piece reproducing order data edited by the managing apparatus is recorded onto a portable recording medium such as a memory stick or the like. By accessing the in-vehicle audio information reproducing apparatus by using the recording medium, a new reproduction address is allocated to the music piece data stored onto the hard disk in the in-vehicle audio information reproducing apparatus.

### BACKGROUND OF THE INVENTION

1. Field of the Invention

The invention relates to an apparatus for managing music piece data and also to an in-vehicle audio information reproduction control system constituted by music piece data managing apparatuses each having a hard disk therein on which music piece data has been stored and an in-vehicle audio information reproducing apparatus.

2. Description of Related Art

In conventional in-vehicle audio information reproducing apparatuses, a multidisk changer is widely used in which a plurality of audio discs such as CD, MD, or the like are housed, so that a desired disk is in turn selected for reproduction from among the housed discs.

In recent years, downsizing and decreased price of hard disks having an extremely large memory capacity have been achieved, and the use of in-vehicle audio information reproducing apparatuses having a hard disk therein is wide spread. In those in-vehicle audio information reproducing apparatuses, music piece data recorded on a large number of discs can be stored in a hard disk, thereby making the most of the large memory capacity of the hard disk. Once music piece data recorded on CDs and MDs is stored onto the hard disk, the user will be able to reproduce and enjoy desired music pieces without the difficulty of exchanging discs.

In such a hard disk, management data including the order of reproduction and additional information such as titles of music pieces, genres of the music pieces, and the like is added to the stored music piece data. Since the in-vehicle audio information reproducing apparatus having the hard disk therein has a function for editing the management data, the order of reproduction can be freely edited according to the user's preference. For example, the order of reproduction of the music pieces can be determined in terms of artists or music genres.

However, if the number of music pieces stored onto the hard disk becomes very large, a long time may be needed to edit the management data mentioned above.

That is, it may take a very long time for the user to search out a desired music piece from the music piece data stored on a large capacity hard disk and execute an editing operation while considering the order of reproduction. If the user tries to execute the editing operation for a long time in a small vehicle space, substantial strain will be placed on the user and there is also a possibility that an erroneous operation occurs in the editing process.

In the in-vehicle audio apparatuses, since the casing is generally small in size, only a small-sized display and a small number of operation keys and the like which are necessary for the editing operation but small in size can be arranged. The user, therefore, has to execute each one of the processes by operating one operation key a plurality of times while looking at a small display screen, so that an operating process to execute the necessary and sufficient editing operations for a number of music piece data, will be considerably troublesome for the user.

### OBJECT AND SUMMARY OF THE INVENTION

The present invention has been made to solve the drawback of conventional systems mentioned above and it is an object of the invention to provide an in-vehicle audio information reproduction control system which does not require editing of the order of reproduction of music piece data by complex operations in a small vehicle space.

According to the invention, there is provided an in-vehicle audio information reproduction control system comprising:

a music piece data managing apparatus including a storage part for storing music piece data and management data associated therewith in a way allowing additional writing, a display part for displaying the management data stored in the storage part and displaying a message to prompt an input operation for instructing an order of reproduction of the music piece data, a reproducing order generating part for generating reproducing order data to determine an order of reproduction of music pieces which are played based on the input operation, and a data transfer part for transferring the reproducing order data by a data transfer media; and

an in-vehicle audio information reproducing apparatus including a storage part for copying the music piece data and the management data which have been stored in the music piece data managing apparatus and storing them, a transfer data reading part for reading the reproducing order data transferred by the data transfer media, and a reproduction control part for collating the reproducing order data read by the transfer data reading part with the management data stored in the storage part and controlling reproduction of the music piece data stored in the storage part based on the order of reproduction designated by the reproducing order data.

### BRIEF DESCRIPTION OF THE DRAWINGS

FIG. 1 is a structural diagram showing a concept of an in-vehicle audio information reproduction control system according to the invention;

FIG. 2 is a block diagram showing the construction of a music piece data managing apparatus in the system of FIG. 1;

FIG. 3 is a block diagram showing the construction of an in-vehicle audio information reproducing apparatus in the system of FIG. 1;

FIG. 4 is a diagram showing the format of data which is stored onto a hard disk of each apparatus in the system of FIG. 1;

FIG. 5 is a structural diagram of the format of reproducing order data, showing an example of the edition of the reproduction order of music pieces in the music piece data managing apparatus of FIG. 2;

FIG. 6 is a diagram showing the format of reproducing order data showing an example of the edition (example of edition in terms of artist or genre) of the reproducing order of music pieces in the music piece data managing apparatus of FIG. 2;

FIG. 7 is a diagram showing the data format in a memory when transferring additional data together with the reproducing order data to the in-vehicle audio information reproducing apparatus in the system of FIG. 1;

FIG. 8 is a flowchart showing an overall operation of the edition of the reproduction order of the music pieces in the music piece data managing apparatus of FIG. 2; and

FIG. 9 is a flowchart showing a reproduction control process of the music pieces in the in-vehicle audio information reproducing apparatus of FIG. 3.

### DETAILED DESCRIPTION OF THE PREFERRED EMBODIMENT

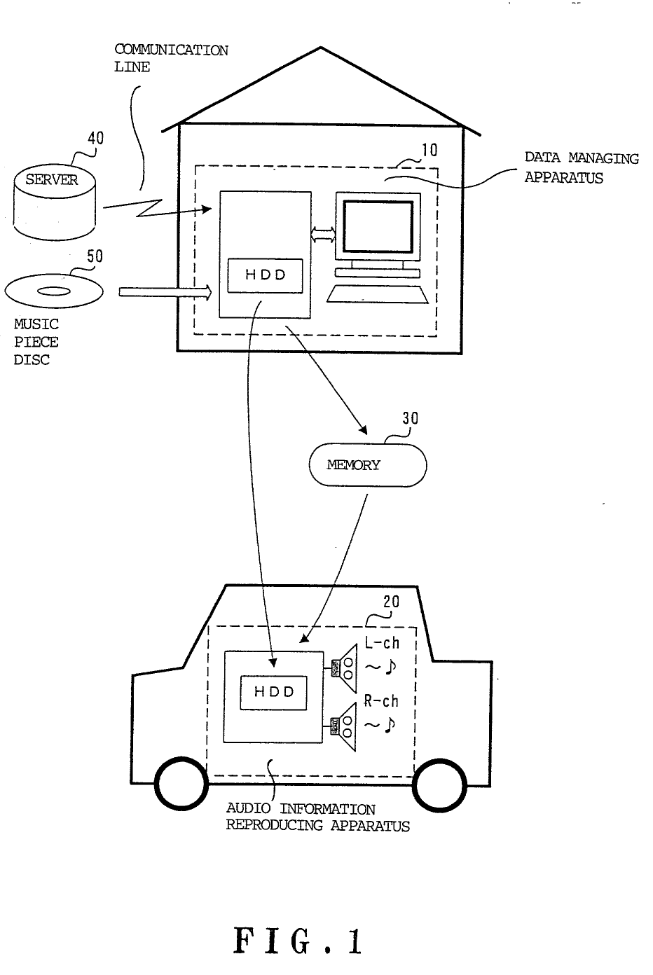

FIG. 1 is a structural diagram showing the concept of an in-vehicle audio information reproduction control system according to the invention.

In FIG. 1, a music piece data managing apparatus 10 is constituted mainly by a personal computer and that may be installed at an indoor place such as an office or the like. The music piece data managing apparatus 10 has a function of obtaining music piece data and data associated therewith from a music piece recording disc or a server connected to a network, storing the data on an internal hard disk, and editing the order of reproduction of the music piece data.

An in-vehicle audio information reproducing apparatus 20 is generally installed in a vehicle and has a function for reproducing the music piece data stored on a built-in hard disk. The hard disk is detachable from a main unit of the in-vehicle audio information reproducing apparatus 20. By connecting the hard disk to the hard disk of the music piece data managing apparatus 10, the data stored on the hard disk of the music piece data managing apparatus 10 can be copied.

A memory 30 is a portable data transfer media such as Memory Stick or the like. By loading the memory into the music piece data managing apparatus 10, the reproducing order data to instruct the order of reproduction of the music piece data edited by the apparatus 10 can be recorded into the memory 30. By removing the memory 30 from the music piece data managing apparatus 10 and loading it into the in-vehicle audio information reproducing apparatus 20, the data recorded in the memory 30 can be transferred to the in-vehicle audio information reproducing apparatus 20.

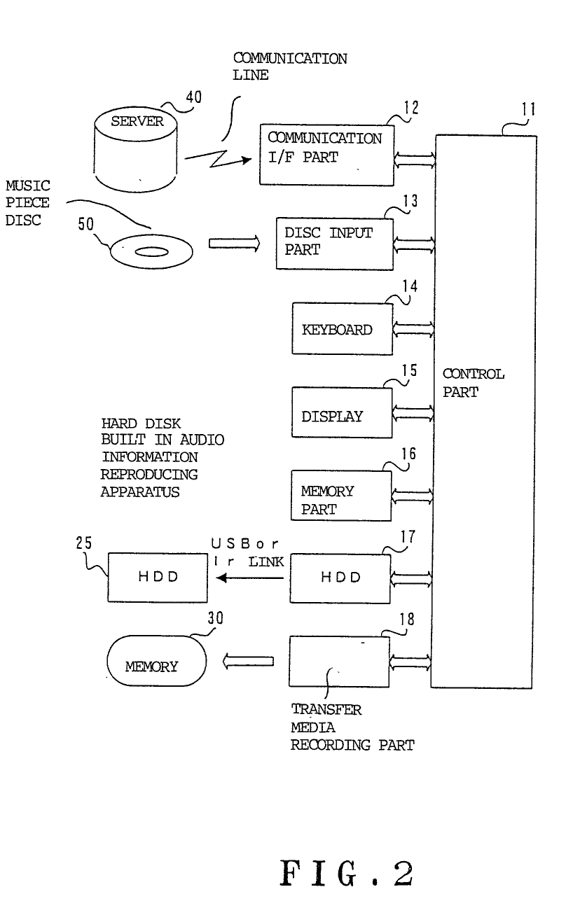

The structure of the music piece data managing apparatus 10 will now be described with reference to a structural diagram shown in FIG. 2.

In the music piece data managing apparatus 10, a control part 11 is constituted mainly by a microcomputer and has a function for controlling the operation of the apparatus as a whole.

A communication interface part 12 has a function for retrieving various music piece data and data associated therewith from a server 40 on a network such as Internet or the like through a communication line such as ISDN, ordinary telephone line, or the like. A disc input part 13 has a function for reading data such as music pieces or the like recorded on a music piece disc 50 such as CD, MD, or the like and storing it into the apparatus.

A keyboard 14 and a display 15 are portions for displaying data and entering an operating instruction when a data inputting process is executed or the reproducing order data of the music pieces is formed.

A memory part 16 is constituted mainly by an ROM and an RAM. A main program for controlling the operation of the apparatus has been previously stored in the ROM. Various process values and the like in the step of the operating process of the apparatus are stored in the RAM.

The music piece data obtained through the communication I/F unit 12 and disc input unit 13 and the management data comprising addresses indicative of storing positions of the music piece data and the data associated with the music piece data have been stored onto a hard disk 17.

A transfer media recording part 18 is a circuit for performing recording of data into the memory 30 as a portable data transfer media when the reproducing order data for designating the order of reproduction of the music pieces is generated by the control part 11 based on the management data or in the case where new music piece data has additionally been obtained through the communication I/F unit 12 and disc input unit 13.

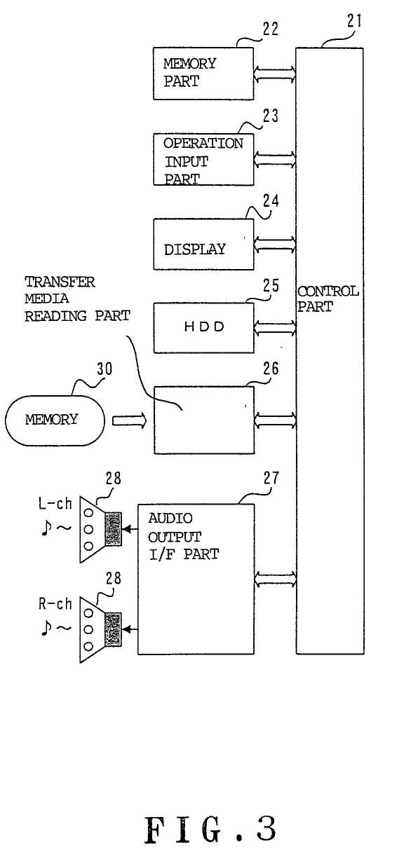

Subsequently, the structure of the in-vehicle audio information reproducing apparatus 20 will be described with reference to a structural diagram shown in FIG. 3.

In the diagram, a control part 21 is constituted mainly by a microcomputer and has a function for controlling the operation of the whole apparatus.

A memory unit 22 is constructed mainly by a ROM and a RAM. A main program for controlling the operation of the apparatus has been stored in the ROM. Various process values and the like in the step of the operating process of the apparatus are stored in the RAM.

An operation input unit 23 is constituted by a ten-key and various function keys arranged on a console panel of the apparatus 20 and used in the case where the user enters an operating instruction and various data. A display 24 is also mounted on the console panel of the apparatus, and comprises, for example, a display device such as LCD, organic EL, or the like. The display functions to display an operating mode of the apparatus and the information such as the order of reproduction of the music piece data or the like stored in the apparatus.

The music piece data and the management data associated therewith which have been copied from the music piece data managing apparatus 10 and are to be reproduced by the apparatus 20 are stored on a hard disk 25.

A transfer media reading part 26 has a function for reading the management data and music piece data recorded in the data transfer media, i. e. the memory 30, from this media when the memory 30 is loaded into the apparatus.

An audio output interface unit 27 is an audio output circuit constituted mainly by a digital signal processor, a D/A converter, an analog amplifying circuit, and the like. The music piece data stored on the hard disk 25 is converted into an analog signal by this circuit based on a reproducing instruction from the control part 21 and, thereafter, generated as an audio signal through speakers 28.

The memory 30 is the portable data transfer media as mentioned above and comprises, for example, a memory device such as a non-volatile RAM such that data can be recorded and retrieved anytime, and recorded contents will not be extinguished even if a power supply of a main part of the memory is turned off.

The operation of the whole system comprising the music piece data managing apparatus 10, in-vehicle audio information reproducing apparatus 20, and memory 30 as a data transfer media shown in FIGS. 1 to 3 will now be described below.

First, the music piece data managing apparatus 10 obtains various music piece data and data associated therewith from the outside of the apparatus. For example, the apparatus 10 retrieves various data which is distributed from the server 40 on the network such as Internet or the like by using the communication I/F unit 12 through a communication line such as ISDN, telephone line, or the like or a broadcasting line such as CATV, BS, CS, or the like. Data recorded on the music piece discs 50 such as various CDs, MDs, or the like can also be read and fetched into the apparatus by using the disc input unit 13.

When those data are retrieved, the music piece data managing apparatus 10 forms memory addresses showing storing positions of the fetched music piece data on the hard disk 17 of the music piece data managing apparatus 10 and stores them onto the hard disk 17 together with the fetched music piece data and the data associated therewith. In this case, the management data is constituted by the memory addresses and the data associated with the music piece data.

As a storing process on the hard disk 17, data are additionally writable. After the obtained data has been stored once, each time the data is obtained from an external source such as a server 40 or the like, it is successively written onto the hard disk 17.

The data stored on the hard disk 17 can be copied onto the hard disk 25 built in the in-vehicle audio information reproducing apparatus 20. As mentioned above, the hard disk 25 of the in-vehicle audio information reproducing 10 apparatus 20 is detachable from the apparatus main body and it can be removed from the main body of the apparatus 20 and placed near the music piece data managing apparatus 10. In the state of the setting mentioned above, by connecting both of the hard disks 17 and 25 by using, for example, a USB (Universal Serial Bus) interface or an Ir (Infrared Rays) link interface, the data stored on the hard disk 17 can be easily copied onto the hard disk 25.

After completion of the copying process of the storage data, by reloading the hard disk 25 into the main body of the stored apparatus 20, that is, by returning it to the loading state before this disk is removed, the in-vehicle audio information reproducing apparatus 20 can reproduce the music piece data stored onto the hard disk 17 of the music piece data managing apparatus 10.

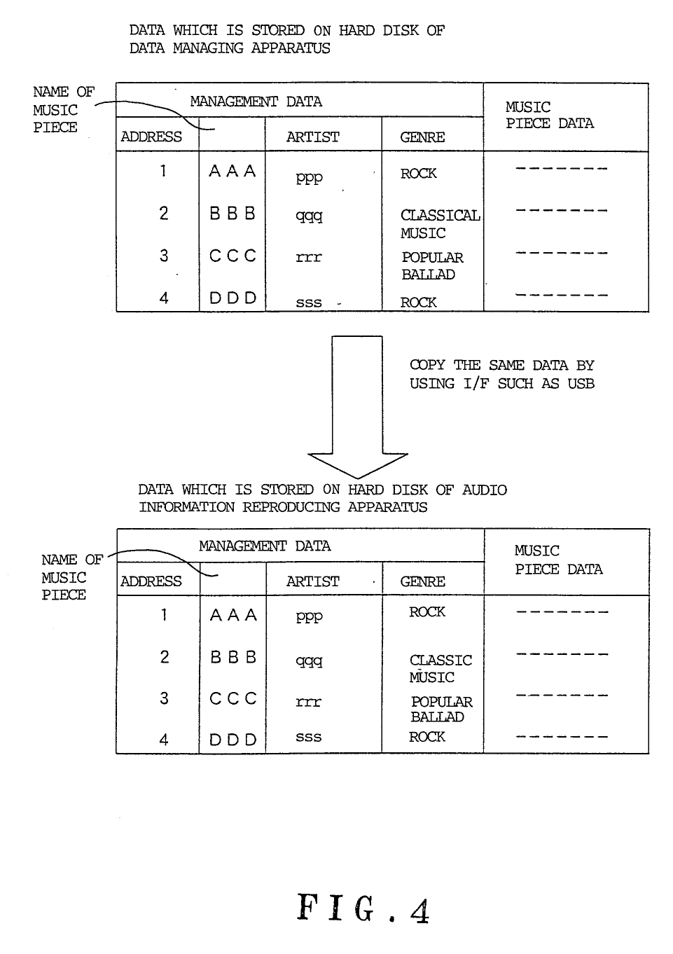

A storage format of the music piece data and the management data onto the hard disk 17 of the music piece data managing apparatus 10 and a state of copying the storage data onto the hard disk 25 of the in-vehicle audio information reproducing apparatus 20 are shown in the structural diagram of FIG. 4 that illustrates the storage data format.

As shown in FIG. 4, in the embodiment, the management data, which is stored onto the hard disks 17 of the music piece data managing apparatus 10, comprises addresses showing the storing positions of the music pieces, names of the music pieces, names of artists, and genres to which the music pieces belong. The artist names and the genres to which the music pieces belong are presented by the so-called text data that represents the attributes of the music piece data.

In FIG. 4, although there is shown that 1st to 4th address data are displayed, the embodiment is not limited to such an arrangment. It is also possible to select any number of addresses which the user desires to handle and copy the data stored in the data managing apparatus 10 onto the hard disk 25 of the in-vehicle audio information reproducing apparatus 20.

Subsequently, the forming operation of the reproducing order data for determining the order of reproduction of the music pieces stored onto the hard disk will be described.

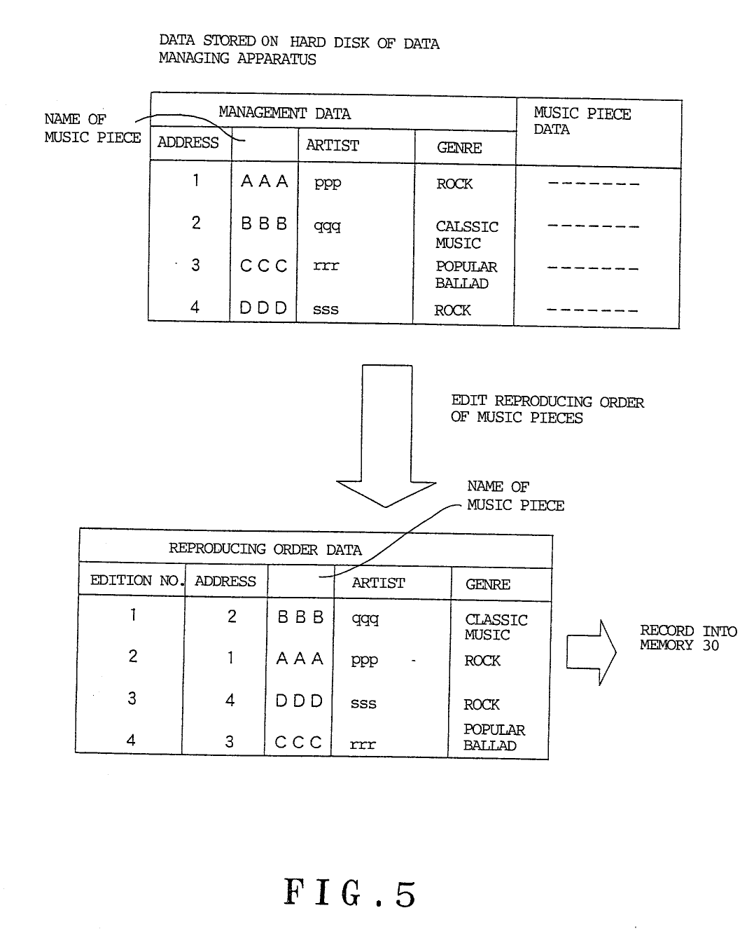

In response to an input instruction from the keyboard 14, the control part 11 of the music piece data managing apparatus 10 executes an editing process for forming the reproducing order data of the music piece data stored onto the hard disk 17. An example of the editing process is shown in FIG. 5.

The editing process is executed by a method whereby the attribute data showing the music piece names, artist names, and music piece genres included in the management data and the memory addresses on the hard disk are rearranged, for example, in the order of reproduction which the user desires by using the memory addresses as a reference and edition numbers showing the order of reproduction of the music piece data are added.

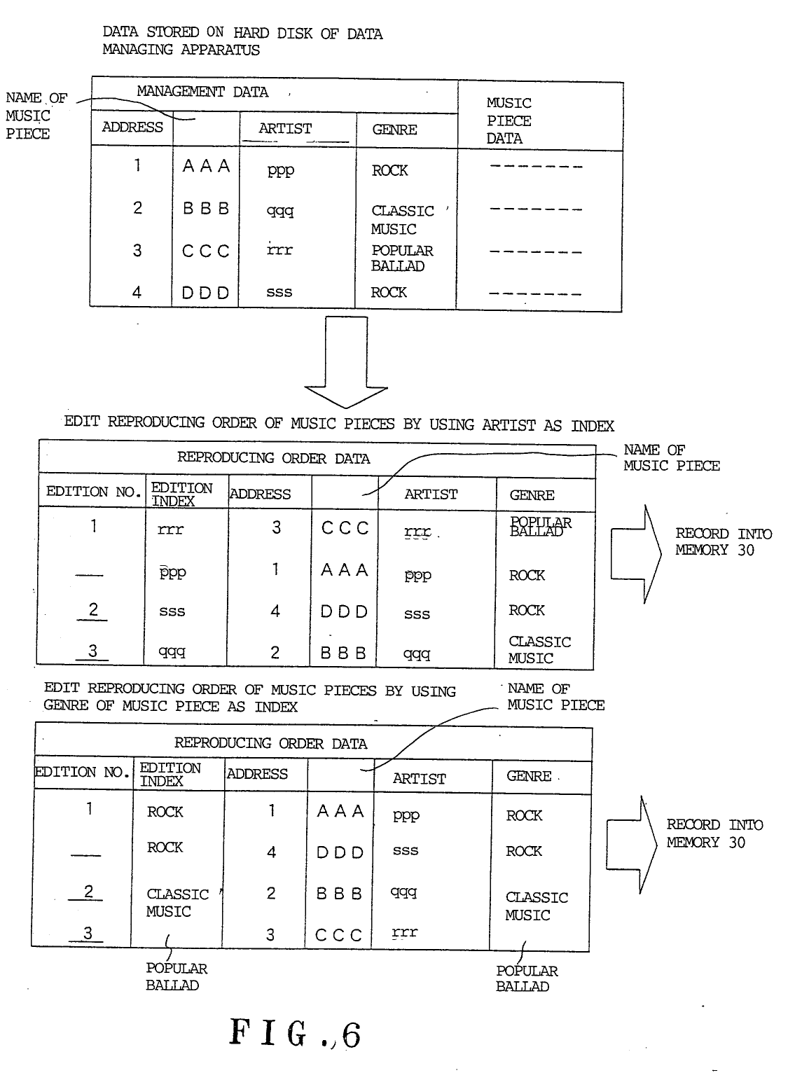

As another example of the editing process, for instance, an editing process as shown in FIG. 6 is also possible. A middle portion of FIG. 6 shows a case where the reproducing order data is formed by using the artist's name of the music piece as an index. That is, the music piece data is segregated into a group for each of the same artist name and the order of reproduction of the music piece data is determined in the order of the names of the artists of the user's preference. In this case, with respect to the order of the reproduction of a plurality of music piece data in the same artist name, for example, it can be also edited by a method of reproducing the music piece data in the ascending order of the memory address, or the like. The editing process is executed by rearranging the music piece data for each artist name in the management data, and by the addion of edition numbers according to the order of reproduction, to every group of the artist name.

In the lower part of FIG. 6, there is shown an example of the edition in which the reproducing order data is formed by using the genre to which the music piece belongs, as an index. That is, the music piece data is classified into a group for each of the same music piece genre and the order of reproduction of the music piece data is determined in the order of the genres of the user's preference. Also in this case, with respect to the order of reproduction of a plurality of music piece data in the same field, for example, it can be freely edited by a method of reproducing the music piece data in the order of the small value of the memory address, or the like. In a manner similar to the middle part of FIG. 6, in the management data in which the order of reproduction of the music piece data has been determined, together with the rearrangement of the data, the edition numbers corresponding to the desired order of reproduction are added to the groups respectively.

As described in detail above, when the editing process is executed in the music piece data managing apparatus 10, reproducing order data is formed in which the data in the management data is rearranged in accordance with the order of reproduction of the music piece data and the edition numbers according to the order of reproduction have been added to the music piece names.

By adopting the reproducing order data in the above format, two data of the edition number and the memory address is added to each music piece name. A collating process of the music pieces in the in-vehicle audio information reproducing apparatus 20, which will be explained later can be performed, consequently.

In the in-vehicle audio information reproducing apparatus 20, in order to reproduce the music piece data stored on the hard disk 25 in the desired reproducing order, it is necessary to transfer the reproducing order data formed by the music piece data managing apparatus 10 to the in-vehicle audio information reproducing apparatus 20. The data transfer can be performed by connecting the hard disks of both apparatuses and copying the reproducing order data to the hard disk 25 on the in-vehicle audio information reproducing apparatus's side as mentioned above.

The copying of data between the hard disks, however, needs a troublesome operating procedure such as removal of the hard disk 25 from the in-vehicle audio information reproducing apparatus 20, connecting process between both hard disks, and reloading of the hard disk 25 into the in-vehicle audio information reproducing apparatus 20. Moreover, even if the troublesome manipulations are executed, the data which is copied in this case is not the music piece data itself but merely the reproducing order data of an extremely small capacity.

In the in-vehicle audio information reproduction control system shown in FIGS. 1 to 3, the method whereby, for example, the memory 30 as a portable data transfer media is used for data transfer between both apparatuses in the above case is used.

That is, in the music piece data managing apparatus 10, after the editing process as shown in FIGS. 5 and 6 has been executed, the memory 30 is loaded into the transfer media recording unit 18 of the apparatus. The reproducing order data subjected to the editing process as shown in FIGS. 5 and 6 is, thus, stored into the memory device in the memory 30 through the transfer media recording unit 18. Subsequently, by removing the memory 30 from the music piece data managing apparatus 10 and loading it into the transfer media reading part 26 of the in-vehicle audio information reproducing apparatus 20, the data recorded in the memory device in the memory 30 is read by the transfer media reading part 26. In this connection, it is also possible to adopt an arrangement that the read-out data is copied into the memory unit 22.

By performing a series of processes as mentioned above, the reproducing order data which was edited and formed in the music piece data managing apparatus 10 can be easily transferred to the in-vehicle audio information reproducing apparatus 20 without needing any troublesome procedure operations.

The control part 21 of the in-vehicle audio information reproducing apparatus 20 collates the reproducing order data read out from the memory 30 with the management data stored on the hard disk 25 by the memory copy between both hard disks shown in FIG. 4 and makes the reproduction control of the music piece data according to the edition numbers designated by the reproducing order data.

The outline of the collating process in the in-vehicle audio information reproducing apparatus 20 is as follows. First, the control part 21 collates the memory addresses according to the edition numbers with the memory addresses stored on the hard disk 25 in the ascending order of edition number of the reproducing order data retrieved from the memory 30. By way of example of the reproducing order data shown at the middle stage of FIG. 6, the control part 21 collates address “3” corresponding to the edition number “1” with memory address “3” stored on the hard disk 25. Subsequently, the control part 21 collates address “1” corresponding to the edition number “1” with memory address “1” stored onto the hard disk 25. Subsequently, similar collating processes are sequentially executed with respect to the edition No. “2” and edition number “3”. The reproduction control of the music piece data stored on the hard disk 25 is made in correspondence to the memory address in each of the collating process. By the execution of the collating process described above, the reproduction control process of the music piece data can be performed for each group according to the attribute of the music piece data such as artist, music piece genre, or the like.

After the copying process between the hard disks shown in FIG. 4 has been executed, when the music piece data managing apparatus 10 additionally obtains a new music piece from the server 40, music piece disc 50, or the like, it can be additionally written onto the built-in hard disk 17 and recorded into the memory device in the memory 30. That is, besides the reproducing order data, the music piece data obtained additionally and the management data associated therewith can be also stored into the memory 30.

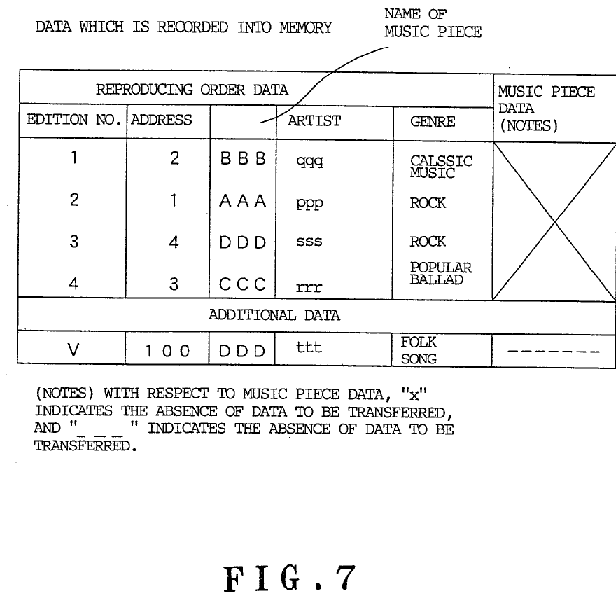

FIG. 7 shows a memory format used when the music piece data which has been additionally obtained and the like are transferred to the memory 30 together with the edited reproducing order data. In the diagram, the management data corresponding to the edition number “V” and the music piece data corresponding to the management data are the data which has been additionally obtained. In FIG. 7, by setting the edition number of the music piece data which has additionally been obtained to “V”, it can be distinguished from the reproducing order data. It is also shown that the address in which the music piece data has been stored on the hard disk 17 is the memory address “100”. In the in-vehicle audio information reproducing apparatus 20 which read the data from the memory 30, therefore, the music piece data which has additionally been obtained and the management data associated therewith are recorded at the memory address “100” on the hard disk 25.

In the in-vehicle audio information reproducing apparatus 20, even if the collating process has been performed, with respect to the music piece data which was additionally obtained, since its edition number is set to “V” and can be distinguished from the edition number (for example, “5”) in the general reproducing order data, the reproduction control process is not executed with respect to the music piece data.

Owing to the processes which have been described in detail above, if the number of music piece data and the management data associated therewith is small, in the music piece data managing apparatus 10, the data which was additionally obtained can be easily transferred to the in-vehicle audio information reproducing apparatus 20 without connecting the hard disks of both apparatuses.

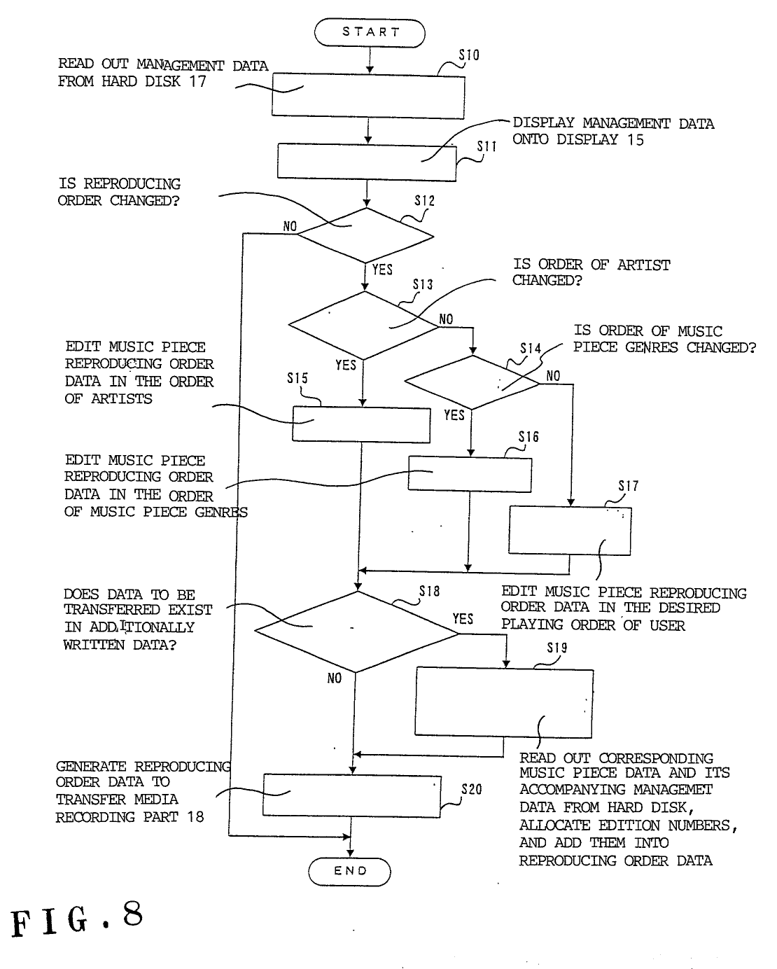

The generation and editing processes of the reproducing order data in the music piece data managing apparatus 10 have been described in FIGS. 5 to 7 with regard to its individual embodiment. The whole flow of the forming and editing processes will be described with reference to a flowchart shown in FIG. 8.

A subroutine for forming the reproducing order data shown in FIG. 8 can be also activated, for example, when an input instruction to form the reproducing order data of the music piece data is issued from the keyboard 14. It can be also activated when the communication I/F unit 12 receives distribution of new music pieces from the server on the network or when the disc input unit 13 loads a new music piece disc.

In the flowchart of FIG. 8, first, the control part 11 of the music piece data managing apparatus 10 controls the hard disk to retrieve the management data (step S10) and controls the display 15 to display it (step S11).

As a result of monitoring the contents displayed on the display, if it is not particularly necessary to change the order of reproduction, the user takes a procedure of finishing the subroutine (step S12).

When the user wants to change the order of reproduction of the music pieces, the processing routine advances to next step S13 and whether the music pieces are reproduced every artist or not is discriminated.

If the user wants to form the order of reproduction music pieces of every artist, the editing process shown at the middle stage in FIG. 6 is executed in step S15 and, thereafter, step S18 follows. If the user does not want to reproduce the music pieces every artist, whether the music pieces are reproduced every genre of the music piece or not is discriminated in step S14.

If the user wants to form the order of reproduction of every music piece field in step S14, the processes shown at the lower stage in FIG. 6 are executed and, thereafter, step S18 follows. If the user does not want the order of reproduction of every music piece genre, the user executes the editing process shown in FIG. 5 in step S17 and, thereafter, step S18 follows.

By executing one of the processes in steps S15 to S17 mentioned above, the data of the music piece names, their attributes, and the like included in the management data is rearranged every order of reproduction which the user wants and, further, the edition No. indicative of the order of reproduction is allocated to each music piece. That is, by the above processes, the reproducing order data to instruct the order of reproduction of the music piece data is formed.

In step S18, the user discriminates the presence or absence of the music piece which was newly added and obtained from the server or the like on the network. If the music piece which has additionally been obtained exists, the user issues an instruction to add it to the previous reproducing order data (step S19) and the processing routine advances to step S20. A format of the reproducing order data in the above case is as shown in FIG. 7.

Assuming that the music piece data which was additionally obtained by the music piece data managing apparatus 10 is certainly transferred to the in-vehicle audio information reproducing apparatus 20, for example, the control part 11 of the music piece data managing apparatus 10 can also automatically execute the processes in steps S18 and S19 irrespective of the will of the user.

In step S20, the control part 11 generates the formed reproducing order data to the transfer media recording unit 18, so that the apparatus enters a state where the reproducing order data can be recorded into the data transfer media at anytime after that.

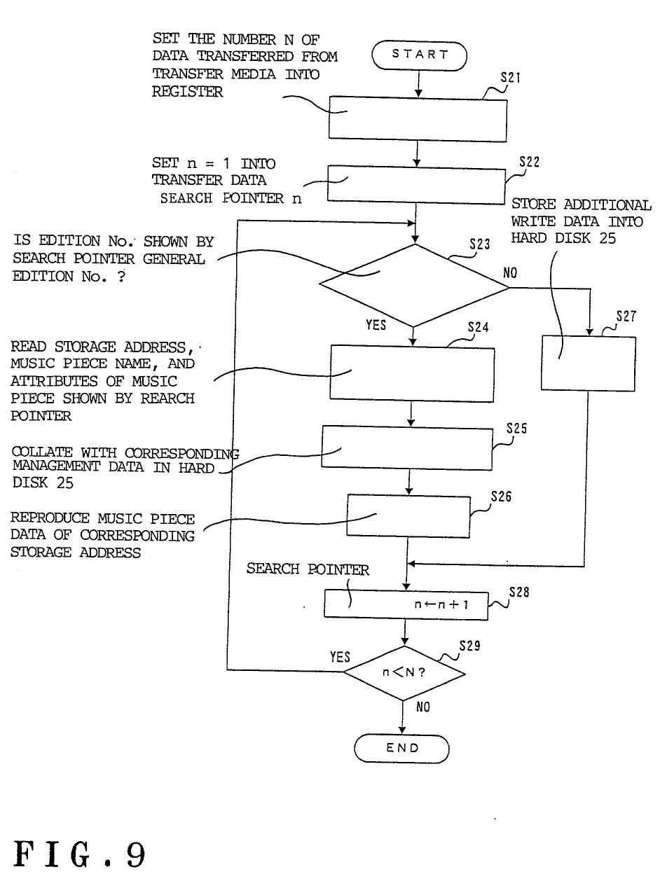

A reproduction processing subroutine of the music piece data in the in-vehicle audio information reproducing apparatus 20 will now be described with reference to a flowchart shown in FIG. 9.

It is also possible to construct the system in a manner such that when the memory 30 in which the reproducing order data has been recorded is loaded into the in-vehicle audio information reproducing apparatus 20, the above subroutine is automatically activated or after the memory 30 was loaded, it is activated when an instruction of the reproducing process is supplied from the operation input unit 23 of the apparatus 20.

In the flowchart shown in FIG. 9, the control part 21 of the in-vehicle audio information reproducing apparatus 20 sets the number (N) of data transferred through the data transfer media, that is, through the memory 30 into a register of the memory unit 22 (step S21). The number (N) of data denotes the total number of music pieces included in the transferred reproducing order data. If the additional writing data is included in the transfer data, further, the number of music pieces included in the additional writing data is also included in the number (N).

In next step S22, the control part 21 executes an ininitializing process for setting a transfer data search pointer n (hereinafter, referred to as a pointer n) to n=1. The pointer n is an index for searching the transferred data. The edition number, memory address, attribute data, and the like included in the transferred data are collected as one data group corresponding to one music piece. The pointer n can be regarded as a count register when used as a measure to search for one transferred data group in such data groups.

When the data group represented by the pointer n is extracted from the transfer data, the control part 21 first examines the edition No. existing at the head of the data group and discriminates whether this edition No. is a general edition number or not (step S23). The general edition number denotes an edition No. shown by an Arabic numeral allocated to each reproducing order data in FIGS. 5 to 7. The edition number other than the general edition numbers denotes an edition No. shown by a Roman numeral allocated to each music piece included in the additional writing data in FIG. 7. The reason why the distinction as mentioned above is provided is to discriminate whether the data group subsequent to the edition No. is the mere reproducing order data or the additional writing data.

The Arabic numerals and Roman numerals showing the edition Nos. in FIGS. 5 to 7 are a mere simile for explaining the discriminating process. In the actual system, for example, the above discrimination can be also made based on a difference of encoding codes of numerals indicative of the edition numbers or the like.

In step S23, if the edition No. is the general edition No., that is, if it is the Arabic numeral, since the data group subsequent to the edition No. is the reproducing order data, the control part 21 reads the data such as memory address, music piece name, and the like from the data group shown by the search pointer (step S24) and collates them with the management data stored on the hard disk 25 (step S25). If there is no error or the like in a collation result, the control part 21 reads out the music piece data stored in the memory address on the hard disk 25 and reproduces it (step S26).

In step S23, if the edition No. indicated by the search pointer n is the edition No. shown by the Roman numerals, this means that the data group indicated by the pointer n is the additional writing data. The control part 21, therefore, stores the data group subsequent to the above edition number. onto the hard disk 25 in accordance with the memory address included in the data group (step S27). The processing routine advances to step S28.

In step S28, the control part 21 increments the value of the pointer n (n=n+1) and, thereafter, compares the total number (N) of transfer data which has been set into the register in step S21 with the value of the pointer n (step S29). When the value of the pointer n is equal to or less than N, the control part 21 returns to step S23 and repeats the above processes, since this means that the processes of all of the transferred data are not completed yet. If the value of the pointer n is equal to N, the present subroutine is finished, since this means that the processes of all of the transferred data have been completed.

As described above, according to the present system, merely by transferring the music piece reproducing order formed by the music piece data managing apparatus 10 to the in-vehicle audio information reproducing apparatus 20 through the memory 30, the order of reproduction of the music pieces in the apparatus can be easily changed. Therefore, with respect to the music piece data stored on the hard disk 25 of the in-vehicle audio information reproducing apparatus 20, the user has to always grasp the orders of reproduction presently selectable for the reproduction control. For this purpose, the in-vehicle audio information reproducing apparatus 20 has the function for displaying the reproducing order data recorded in the memory 30 and the reproducing order data recorded in the memory unit 22 onto the display 24 in response to an operating instruction from the operation input unit 23.

A generally used memory device such as a non-volatile RAM or the like, which holds the storage contents for a long period of time even if the power source is turned off, is used as a memory 30. The user, therefore, can also use a plurality of memories 30 in which the order of reproduction according to his favor has been recorded. By properly selectively using those memories 30 in accordance with time and place, the user can enjoy playing many music pieces in accordance with the desired order of reproduction without needing any troublesome operations in the in-vehicle audio information reproducing apparatus 20.

In the embodiments shown in FIGS. 1 to 3, although the memory 30 as a portable small-size recording medium is used as a data transfer media for transferring the data between the music piece data managing apparatus 10 and in-vehicle audio information reproducing apparatus 20, the data transfer media in the invention is not limited to it.

For example, it is also possible to use a data transfer media for transferring data between the music piece data managing apparatus 10 and in-vehicle audio information reproducing apparatus 20 by using a radio transmitting apparatus like a Bluetooth that uses a very weak radio wave of a band of 2.4 GHz for which a license is not required. In this case, a buffer memory for temporarily storing data which is transferred and a master side transmitter in a Bluetooth system are connected to the transfer media recording unit 18 of the music piece data managing apparatus 10. A slave side receiver in the Bluetooth system and a buffer memory for storing the received data are connected to the transfer media reading part 26 of the in-vehicle audio information reproducing apparatus 20.

As a transferring method of the reproducing order data when using the data transfer media mentioned above, the control part 11 can also activate the Bluetooth system as a data transfer media each time the editing operation of the order of reproduction of the music piece data is executed in the music piece data managing apparatus 10. It is also possible to arrange the present system to be activated by an interruption signal at predetermined time intervals.

According to the in-vehicle audio information reproduction control system of the invention, the order of reproduction of the music piece data stored in the in-vehicle audio information reproducing apparatus can be edited on the music piece data managing apparatus (personal computer) installed at an indoor place which is away from the above apparatus and where an environment is good. The editing operation, therefore, can be extremely easily performed and labor of the editing operations can be reduced.

As described above, the order of reproduction of the music piece data can be stored onto the recording medium such as a portable memory stick or the like. Therefore, by preparing a plurality of recording media and exchanging them and loading into the in-vehicle audio information reproducing apparatus, the user can easily enjoy playing of the music pieces in the various orders of reproduction.

The present invention is based on Japanese Patent Application No. 2000-323730 which is hereby incorporated by reference.

What is claimed is:

1. A music piece data managing apparatus comprising:
a storage part for storing music piece data and management data associated therewith in a manner allowing additional writing;
a display part for displaying the management data stored in said storage part and displaying a message to prompt an input operation for instructing an order of reproduction of said music piece data;
a reproducing order generating part for forming reproducing order data to determine an order of reproduction of music pieces based on said input operation; and
a data transfer part for transferring said reproducing order data by a data transfer media.

2. An apparatus according to claim 1, wherein said reproducing order generating part rearranges said management data in accordance with the reproducing order of the music pieces and allocates edition numbers representing the order of reproduction to said management data, thereby forming the reproducing order data.

3. An apparatus according to claim 1, wherein
said management data includes a music piece name of the music piece data, data indicative of attributes of said music piece, and a memory address indicative of a storing position of said music piece data in said storage part, and
said reproducing order generating part forms the reproducing order data for determining an order of reproduction of the music piece data with respect to each of said music piece names, attribute data, or said memory addresses based on said input operation.

4. An apparatus according to claim 2, wherein
said management data includes a music piece name of the music piece data, data indicative of attributes of said music piece, and a memory address indicative of a storing position of said music piece data in said storage part, and
said reproducing order generating part forms the reproducing order data for determining an order of reproduction of the music piece data with respect to each of said music piece names, attribute data, or said memory addresses based on said input operation.

5. An apparatus according to any one of claims 1 to 4, wherein
said reproducing order generating part generates said reproducing order data and adds additional writing data comprising the music piece data and the management data associated therewith which have been additionally written onto said storage part to said formed reproducing order data, and
said data transfer part transfers the reproducing order data to which said additional writing data has been added by said data transfer media.

6. An apparatus according to any one of claims 1 to 4, wherein a portable data recording medium is used as said data transfer media.

7. An apparatus according to claim 5, wherein a portable data recording medium is used as said data transfer media.

8. An in-vehicle audio information reproducing apparatus comprising:
a storage part for storing music piece data and management data copied from a music piece data managing apparatus which stores the music piece data and the management data;
a transfer data reading part for reading the reproducing order data transferred by said data transfer media; and
a reproduction control part for collating the reproducing order data read by said transfer data reading part with the management data stored in said storage part and controlling reproduction of the music piece data stored in said storage part based on the order of reproduction designated by said reproducing order data.

9. An apparatus according to claim 8, wherein
when the reproducing order data to which additional writing data has been added is read, said transfer data reading part notifies said storage part of said reproducing order data, and
said storage part stores the music piece data included in said additional writing data based on an address indicated by the management data included in said additional writing data.

10. An apparatus according to claim 8 or 9, further comprising a display part for displaying said reproducing order data read by said transfer data reading part.

11. An in-vehicle audio information reproduction control system comprising the music piece data managing apparatus according to any one of claims 1 to 4 and an in-vehicle audio information reproducing apparatus which comprises:
a storage part for storing music piece data and management data copied from a music piece data managing apparatus which stores the music piece data and the management data;
a transfer data reading part for reading the reproducing order data transferred by said data transfer media; and
a reproduction control part for collating the reproducing order data read by said transfer data reading part with the management data stored in said storage part and controlling reproduction of the music piece data stored in said storage part based on the order of reproduction designated by said reproducing order data.

12. An in-vehicle audio information reproduction control system comprising the music piece data managing apparatus according to any one of claims 1 to 4 and an in-vehicle audio information reproducing apparatus which comprises:
a storage part for storing music piece data and management data copied from a music piece data managing apparatus which stores the music piece data and the management data;
a transfer data reading part for reading the reproducing order data transferred by said data transfer media; and
a reproduction control part for collating the reproducing order data read by said transfer data reading part with the management data stored in said storage part and controlling reproduction of the music piece data stored in said storage part based on the order of reproduction designated by said reproducing order data, wherein
when the reproducing order data to which additional writing data has been added is read, said transfer data reading part notifies said storage part of said reproducing order data, and
said storage part stores the music piece data included in said additional writing data based on an address indicated by the management data included in said additional data writing.
